(19) United States
(12) Patent Application Publication
(10) Pub. No.: US 2026/0043278 A1
(43) Pub. Date: Feb. 12, 2026

(54) MOTOR VEHICLE LOCK WITH IMPROVED DOOR OPENER

(71) Applicant: Kiekert Aktiengesellschaft, Heiligenhaus (DE)

(72) Inventors: Andreas SOHLBACH, Mülheim an der Ruhr (DE); Armin HANDKE, Duisburg (DE); Uwe REDDMANN, Essen (DE)

(73) Assignee: Kiekert Aktiengesellschaft, Heiligenhaus (DE)

(21) Appl. No.: 19/100,609

(22) PCT Filed: Jul. 21, 2023
(86) PCT No.: PCT/EP2023/070318

§ 371 Date: Feb. 3, 2025

(30) Foreign Application Priority Data
Aug. 8, 2022 (DE) 10 2022 119 847.2

(51) Int. Cl. E05B 77/38; E05B 81/04

(52) U.S. Cl. CPC E05B 77/38; E05B 81/04

(57) ABSTRACT

The invention relates to a motor vehicle lock, comprising a locking mechanism which has a rotary latch and at least one pawl, wherein the rotary latch can be latched in at least one latching position by means of the pawl and the locking mechanism can be placed in engagement with a lock striker (28), a run-in buffer (21) arranged in a housing (31) of the motor vehicle lock, wherein the run-in buffer (21) can be placed in engagement with the lock striker (28), and an opening device which is arranged at least partially in the motor vehicle lock, wherein the opening device has an opener (20), and the opener (20) can be placed in engagement with the lock striker (28), wherein the opener (20) interacts with the run-in buffer (21).

The invention relates to a motor vehicle lock having a locking mechanism with a rotary latch and at least one pawl, wherein the rotary latch can be latched in at least one latching position by means of the pawl and the locking mechanism can be placed in engagement with a lock striker; a run-in buffer arranged in a housing of the motor vehicle lock, wherein the run-in buffer can be placed in engagement with the lock striker; and an opening device arranged at least partially in the motor vehicle lock, wherein the opening device has an opener, and the opener can be placed in engagement with the lock striker.

Motor vehicle locks, which are also referred to as motor vehicle closing devices or simply closing devices, are used where vehicle parts that are attached to the motor vehicle in a pivoting or sliding manner have to be held in a mostly closed position. The vehicle parts must maintain their position while the vehicle is in motion and protect the occupant, for example, in the event of an accident in the motor vehicle.

To increase comfort in motor vehicles and/or due to the design on the motor vehicle, more and more electrically assisted closing devices are being used. For example, an electrically operated latch can be used when an exterior door handle is not required. In this case, the operator can open the motor vehicle by giving a switching signal to the closing device. It can then be advantageous to provide the closing device or the movable component with an opener. Opening a side door can make it easier to get into vehicles without door handles, for example. Such opening devices are also called door openers or display devices.

DE 10 2011 015 669 A1 describes an opening device for motor vehicle doors or hatches by means of which a door, hatch, or hood can be converted from a closed position to an open position. For example, if the opening device relates to a motor vehicle side door, the door can be opened by the operator by means of an electrical signal. To do this, the locking mechanism of the door lock must first be electrically unlocked so that the door can be opened. The door can then be converted to an open position by means of the opening device. An open position is defined here in such a way that the operator of the motor vehicle is able to grasp the door so that he can fully open the door. The opening device used here is an electric drive that acts mechanically upon the motor vehicle door via a drive pawl and an inner and outer lever in the form of a pivoting movement of the levers.

From DE 10 2017 124 282 A1 an opening device for a motor vehicle door element has become known, having an electric drive and an actuating means, wherein the actuating means can be adjusted by means of the drive and a transmission arranged between the actuating means and the drive. The door can be moved by means of the opening device, wherein a sliding element is arranged on the actuating element, which interacts with a switching means so that the door can be detected. The actuator is substantially formed from a driven toothed rack having an integrated sliding element, switching means, and electrical supply line. It is possible to control the movement of the driven toothed rack by means of the switching means between the sliding element and the body.

The motor vehicle closing devices according to the invention have a locking mechanism consisting of a rotary latch and a pawl. The rotary latch is rotatably or pivotably accommodated in the closing device and can be held in at least one latching position, i.e., locked, by means of the pawl. In most cases, the closing device is arranged in the vehicle part that is pivotably arranged on the motor vehicle, as is common, for example, for side doors. Of course, the closing device can also be arranged on the body, for example, as is often the case with tailgates. The closing device interacts with a lock striker, which is attached to the body, for example, and may be designed as a lock striker bracket or bolt. When closing the component movably arranged on the motor vehicle, the relative movement between the closing device and the lock striker causes the rotary latch to pivot and to be held or secured in a pre-latching position and/or a main latching position by means of the pawl.

The run-in buffer serves, as the name suggests, to dampen a closed position of the movable component and, there, to dampen the movement of the interaction between the lock striker and the vehicle lock. Moreover, when the motor vehicle is in motion, there are usually movements in the body and relative movements between the vehicle part that is pivotally arranged on the body, which in turn results in relative movements between the rotary latch and the lock striker. These relative movements between the lock striker and the rotary latch can cause noises, also known as creaking. In order to influence and, above all, reduce the noise behavior between the lock striker and the closing device, damping means are used, also known as stop buffers, or run-in buffers, or run-in mouth buffers. Various possibilities for influencing the noise behavior between the closing device and the lock striker have become known from the prior art.

DE 10 2010 005 843 A1 discloses a run-in buffer made of a rubber-elastic material that interacts with the lock striker in the main latching position. The run-in buffer serves on the one hand to reduce the noise when the lock striker strikes the closing device, and at the same time to guide the lock striker in the closing system during travel. In accordance with this document, the run-in buffer additionally has an insert formed from an inelastic material-in this case, a polyoxymethylene (POM). The insert placed on the rubber-elastic buffer allows the lock striker to nestle without an overload of the buffer occurring.

From DE 10 2011 107 877 A1, a lock for a door of a motor vehicle has become known, wherein a spring plate oriented substantially parallel to the rotary latch is arranged in the lock, wherein the spring plate comprises the lock striker in the main latching position of the lock. The spring plate is intended to prevent creaking in the area where the lock is connected to the body. In addition to the damping means known from the prior art, this spring plate absorbs possible movements of the corresponding door or hatch perpendicular to the direction of travel of a motor vehicle. A direction perpendicular to the direction of travel is also referred to as the Z direction in a coordinate system referenced to the motor vehicle.

A combination of a run-in buffer and an opening device has become known from DE 10 2020 109 770 A1. As part of the opening device, an opener takes on the function of a run-in buffer. In this exemplary embodiment, the run-in buffer is formed integrally with the opener and may, for example, be molded onto the opener in the form of a rubber-elastic plastic. It is of course also conceivable that the rubber-elastic buffer be connected to the opener by means of a form-fit. Together with the opener, the run-in buffer forms the damping means with which the lock striker can be inserted into the motor vehicle closing device or motor vehicle lock in a noise-dampened manner.

The solutions known from the prior art have generally proven themselves in principle, but reach their limits where there is little space for implementing the above-mentioned functions, in particular a damping function in combination with an opening function, and where holding in the opening position is required. The invention aims to remedy this and, in particular, to demonstrate an improvement.

The object of the invention is to provide a motor vehicle lock which realizes an opening function in the motor vehicle with the smallest possible installation space and at the same time enables a low-noise interaction between the closing device and the lock striker and, moreover, makes it possible to hold the movable component in the opening position. Moreover, the object of the invention is that of providing a structurally simple and inexpensive solution.

According to the invention, the object is achieved by the features of independent claim 1. Advantageous designs of the invention are specified in the dependent claims. It should be noted that the exemplary embodiments described below are not restrictive; rather, any variation of the features described in the description and the dependent claims is possible.

According to claim 1, the object of the invention is achieved in that a motor vehicle lock is provided, having a locking mechanism with a rotary latch and at least one pawl, wherein the rotary latch can be latched in at least one latching position by means of the pawl, and the locking mechanism can be placed in engagement with a lock striker; a run-in buffer, wherein the run-in buffer can be placed in engagement with the lock striker; and an opening device arranged at least partially in the motor vehicle lock, wherein the opening device has an opener, and the opener can be placed in engagement with the lock striker, and the opener interacts with the run-in buffer. The design of the motor vehicle lock according to the invention now makes it possible to provide an opening function in combination with a damping means where opening and damping of a movement of a component that is movable on the motor vehicle can be realized with the smallest possible installation space. According to the invention, the run-in mouth buffer has a multiple function. Firstly, the run-in buffer in conjunction with the lock striker has the function of damping the closing movement, secondly, the run-in buffer serves to reduce a relative movement between the lock and the lock striker in the closed position of the motor vehicle lock in order to prevent so-called creaking, and thirdly, the run-in buffer serves to open the component movably arranged on the motor vehicle—preferably a side door. This multiple function of the run-in buffer can be realized according to the invention in that the opener acts directly upon the run-in buffer or works together with the run-in buffer.

When referring to a motor vehicle lock according to the invention, terms such as motor vehicle closing device or closing system are also common designations for a motor vehicle lock, which are used as synonyms in motor vehicle technology. All these closing devices have in common that a locking mechanism is used in which a pivoting or rotary latch arranged in the locking mechanism interacts with at least one pawl. The rotary latch and pawl are mounted on metal bolts in a metal lock plate so that even the highest loads, such as those that occur in an accident, can be absorbed. In some cases, reinforcing plates are still used between the axles to stabilize the locking mechanism parts. The pawl allows the locking mechanism to assume a pre-latching position and/or a main latching position. One pawl can be used to latch the locking mechanism in two latching positions, but it is also conceivable to use two pawls for the latching positions. It is also conceivable and known that two pawls are used which engage with one another and thereby facilitate unlocking of the locking mechanism; these locking mechanisms are also referred to as two-pawl locking mechanisms and have a closing moment at least in the main latching position.

The lock striker is usually attached to the body and interacts with the locking mechanism through the movement of the closing device in the vehicle part movably arranged on the motor vehicle. The relative movement between the closing device and the lock striker allows the locking mechanism to be converted into the latching position or latching positions. The relative movement between the closing device and the lock striker results in a noise, which can be reduced by the run-in buffer.

The opening device is preferably electrically drivable, wherein the electrical drive device for the opening device can be a direct part of the motor vehicle lock, and/or can be adapted to the motor vehicle lock, and/or is arranged as a separate drive device at a distance from the motor vehicle lock in the motor vehicle. It is also conceivable, for example, that the opener be able to be operated directly or indirectly by means of a Bowden cable. An electrical operation offers the advantage that a power supply is available in the motor vehicle in a variety of ways. By means of a lever mechanism, which can be driven by the drive device, on the one hand, sufficient force can be provided for opening the component and, on the other hand, the paths or opening movements of the movable component can be adjusted. The distance the movable vehicle part travels from its closed position to an open position is referred to as the opening distance. The adjustment distances considered in the context of the invention are on the order of magnitude of less than 20 mm, preferably less than 10 mm, and even more preferably around 5 mm.

The run-in buffer or run-in mouth buffer is arranged at least partially in a housing of the motor vehicle lock. “Arranged” here means that the run-in buffer is fixedly attached to the housing of the motor vehicle lock, at least partially. The housing, forming a run-in mouth, of the motor vehicle lock is usually made of plastic and is preferably manufactured as an injection-molded component. The housing is at least partially surrounded by a lock plate or a lock case, wherein the run-in mouth is also at least partially enclosed by the lock plate or the lock case. The run-in buffer serves to buffer or dampen the relative movement between the vehicle lock and the lock striker, when closing the movable component, to enable very low-noise closing of the movable component—for example a flap, a sliding door, or a side door.

According to the invention, the run-in buffer is connected to the housing such that the run-in buffer is fixedly positioned in the motor vehicle lock and in the run-in mouth of the motor vehicle lock. Typically, the motor vehicle lock moves, e.g., with a side door, and engages with the lock striker that is fixed in place, for example, on a B or C pillar of the body. When the movable component is closed, the lock striker then moves the rotary latch of the locking mechanism, and at least one pawl latches the rotary latch in a pre-latching or main latching position. During closing, the run-in buffer dampens the movement of the moving component and also serves to realize a quiet holding of the movable component during the operation of the motor vehicle.

In an advantageous design variant of the invention, the run-in buffer is movable at least partially by means of the opener. This reveals a significant advantage of the invention, viz., that the opener can itself move the run-in buffer, which is at least partially accommodated in the housing. This makes it possible to use existing components, in particular the run-in buffer, as a means for opening the movable component. In other words, the run-in buffer present in the motor vehicle lock is used to initiate an adjustment movement in the movable component. To do this, the opener engages with the run-in buffer and is able to move the run-in buffer at least partially. In combination with opening of the locking mechanism, the run-in buffer can accordingly serve to initiate the opening movement of the movable component and to transfer the movable component from a closed position to an open position. The opener serves, in combination with the run-in buffer, as an opening means for the movable component. Since the run-in buffer is arranged at least partially, preferably completely, between the opener and the lock striker, a dampened opening can also be made possible.

If the run-in buffer is at least partially accommodated in the housing of the motor vehicle lock, an advantageous design variant can again be achieved. By accommodating the run-in buffer, a precise arrangement of the run-in buffer in the vehicle lock can be achieved. In other words, the known arrangement of the run-in buffer can be used that results in structural advantages. Usually, run-in buffers are arranged in the housing of the motor vehicle lock so that an interaction between the run-in buffer and the lock striker is possible, as described in the introduction, preferably as a stop and to minimize noise. This structural arrangement can be used according to the invention, wherein only a regional freedom from play of the run-in buffer must be realized. In other words, a known structural arrangement of the run-in buffer can be used to fix the run-in buffer in the housing; it is necessary to realize only a partial mobility of the run-in buffer. The opener can then access the movable part of the run-in buffer and initiate or cause a relative movement between the vehicle lock and lock striker.

It can also be advantageous and form an embodiment of the invention if the run-in buffer is at least partially and flexibly connected to the opener. Connecting the opener to the run-in buffer can lead to stabilization of the opener itself. The run-in buffer is at least partially fixed to the housing of the motor vehicle lock and is accordingly partially fixed in the motor vehicle lock. If the opener is coupled with the run-in buffer so that a detachable or non-detachable connection is realized between the run-in buffer and the opener, reliable interaction between the opener and the run-in buffer can be realized. Depending upon the embodiment, the run-in buffer can be detachably or non-detachably connected to the opener. Due to the high rigidity of the plastic of the run-in buffer, a guide can also be provided for the opener; in other words, the run-in buffer serves as a guide for the opener.

In the case of a detachable connection between the run-in buffer and the opener, form-fit or force-fit connections between the opener and the run-in buffer are possible. For example, there may be a recess in the opener in which the run-in buffer engages so that a form-fit connection between the run-in buffer and the opener can be realized. It is of course also conceivable that there be an opening in the run-in buffer in which the opener engages. Overall, the detachable connection between the opener and run-in buffer enables a secure interaction between the run-in buffer and opener, while also making installation easier because the opener and the run-in buffer can be mounted separately.

In the case of a force-fit between the opener and the run-in buffer, the elasticity of the run-in buffer can, for example, be adjusted in such a way that the interaction of tolerances and elasticity of the run-in buffer enables a force-fit connection between the opener and the run-in buffer to be realized. For example, an opening in the run-in buffer can be tolerated in such a way that, after inserting the opener into the opening of the run-in buffer, a force-fit is established between the opener and the run-in buffer. Means for supporting the form-fit may also exist, such as a spring element, wherein the spring element, for example, overlaps the run-in buffer.

In the case of a non-detachable connection between the run-in buffer and opener, material-bonding methods such as gluing are used. However, it is also conceivable that a non-detachable connection between the run-in buffer and opener can be created by means of vulcanization. A material or non-detachable connection between the opener and run-in buffer can in turn ensure reliable interaction between the opener and the run-in buffer. In addition, there are also advantages in terms of assembly, since the number of components to be assembled is reduced because the opener and run-in buffer are a single piece.

If the opener can be placed in engagement with the run-in buffer substantially in the center of the run-in buffer, a further design variant of the invention can be achieved. The central engagement of the opener on the run-in buffer offers the possibility of reducing to a minimum the installation space required for opening. The run-in buffer, usually arranged in the vehicle lock, determines the width of the run-in mouth. Additional installation space for the opener, with reference to the width of the run-in buffer, is not required, since the run-in buffer works in the region of the run-in buffer.

This shows a significant advantage of the invention, viz., that the opener can be integrated into an existing width of a lock, in relation to the width orientation of the run-in buffer, in the motor vehicle lock, without requiring additional installation space, still in relation to the width direction of the run-in buffer. The installation space is a decisive advantage in the development of motor vehicle locks, since the installation space in the interior the motor vehicle, e.g., in a tailgate or a side door, is always limited. This is also due to the fact that additional functions are integrated into the interior of the motor vehicle, such as airbags, closing drives, door module supports, etc. By arranging the opener in the area of the thickness and approximately in the middle of the run-in buffer, the width of the run-in buffer can determine the width of the run-in mouth in the motor vehicle lock with regard to the design, without additional installation space being required for the opener.

If a relative movement between the motor vehicle lock and the lock striker can be produced or achieved by means of a movement of the run-in buffer, this yields a further design variant of the invention. The opener is able to move the run-in buffer at least partially. The opener moves a part, movably arranged in the motor vehicle lock housing, of the run-in buffer in such a way that an unlocked locking mechanism releases the lock striker, and the opener can move the movable component over an adjustment distance from a closed position to an open position. In other words, the flexibility of the run-in buffer is used to initiate an adjusting movement in the moving component. The stationary run-in buffer is able to realize an adjusting movement, i.e., the movable part of the run-in buffer can follow the movement of the opener or is moved by the opener.

If the run-in buffer encloses the lock striker at least partially, a further design variant of the invention can be achieved. In this case as well, a significant advantage of the invention is again evident, viz., that, by moving the run-in buffer and at least partially enclosing the lock striker, a stable position can be achieved even in the open position of the movable component. The run-in buffer therefore has a fourth task, viz., that the run-in buffer can hold, i.e., position, the movable component in the open position. The run-in buffer accordingly becomes a holding means in the open position and prevents the, for example, side door located in the open position from carrying out any independent movement.

The movable component is accordingly holdable by means of the run-in buffer. The run-in buffer can, for example, realize a form-fit engagement between the run-in buffer and the lock striker by means of a rib or a rib structure. It is also possible that the run-in buffer be moved by the opener in such a way that the form-fit occurs only during the opening. In other words, the movable part of the run-in buffer is moved in such a way that, in the open position, a form-fit is established between the lock striker and the run-in buffer.

According to the invention, the component movably arranged on the motor vehicle can be held in at least one installation position by means of the run-in buffer. An installation position is created when the locking mechanism releases the component, e.g., a side door, movably arranged on the motor vehicle. Preferably, the locking mechanism is equipped with an electrically opening drive. After an electrical unlocking of the locking mechanism, i.e., the electrical opening of the locking mechanism, the pawl is lifted off the rotary latch, and the rotary latch can essentially move freely. When the rotary latch releases the movable component, the opener is activated. The opener moves the movable component into an open position, wherein the open position is characterized in that an operator can grasp the movable component. The operator can, for example, reach into a door gap and open the door element for entry. In order to be able to hold in the open position the movable component located in the open position, the invention proposes that the run-in buffer moved by the opener have a holding or fixing effect on the door element. The locking mechanism and the run-in buffer work together with the lock striker. In the open position, the opener has moved the run-in buffer in such a way that the movable component has moved into the open position, but the run-in buffer is still in engagement with the lock striker. If, according to the invention, the movement of the opener and the deformation of the run-in buffer cause the run-in buffer to enclose the lock striker at least partially, a holding engagement can be established between the run-in buffer and the lock striker. The run-in buffer is usually made of a rubber-elastic material. Once the run-in buffer lies in a form-fit in the lock striker, this can ensure on the one hand that the moving component is held securely, and on the other, the operator can easily release the engagement between the run-in buffer and the lock striker.

The side door, for example, which is in the open position, can accordingly be released from holding engagement with the run-in buffer by, for example, pulling on the door element.

Advantageously and in one design variant of the invention, the motor vehicle lock is designed as an electric lock so that an electrical opening of the locking mechanism is possible. By using an electric lock, it is possible to dispense with, for example, an internal actuation and/or an external actuation as mechanical connections to the vehicle lock. To open the motor vehicle lock or to unlock the locking mechanism, it is sufficient to transmit an electrical pulse or a signal to the electric lock in order to unlock the vehicle lock. This gives the motor vehicle designer the option of using electrical actuations or radio remote controls and, for example, dispensing with an interior door handle and/or an outside door handle for unlocking the locking mechanism, since mechanical redundancy for opening the locking mechanism can be omitted.

In a further advantageous design variant of the invention, the run-in buffer serves as a means for damping at least one end position of the opener. When the movable component is in the closed position, the lock striker lies on the run-in buffer and/or opener. In any case, the opener is in its final position, which it assumes when the door element closes. With a mechanical or electrical opening command to the vehicle lock, the locking mechanism is released, and the opener moves the movable component into the open position. In so doing, the opener assumes a second end position or open position. The opener moves back and forth between these two positions or locations in order to move the movable component on the one hand, and to enable the locking mechanism to close again on the other. The opener works together with the run-in buffer and can, for example, also be connected to the run-in buffer in a form-fit and/or material-fit. In order to limit the movement of the opener and/or to be able to reach the end positions with as little noise as possible, the run-in buffer can simultaneously serve as an end position buffer for the opener. If, for example, the opener is moved back to the end position, i.e., the starting position, after being open, the run-in buffer connected to the opener can be moved, for example, against a large wall or a housing region of the motor vehicle lock so that, using the run-in buffer, end position damping can be achieved by the run-in buffer. The same applies to the open position, i.e., the second end position of the opening device.

The design of the motor vehicle lock according to the invention makes it possible to position the interaction between the opener and the run-in buffer and the arrangement of the opener in the motor vehicle lock in such a way that several advantageous functions can be realized by the run-in buffer and the interaction between the opener, the run-in buffer, and the lock striker. The run-in buffer has several functions that range from damping, reducing creaking noises, opening, and holding the movable component in an open position. All these functions can be realized with minimal design effort and installation space.

The invention is explained in more detail below with reference to the accompanying drawings on the basis of a preferred exemplary embodiment. However, the principle applies that the exemplary embodiment does not limit the invention, but is merely an advantageous design. The features depicted can be implemented individually or in combination with further features of the description as well as what is claimed-individually or in combination.

In the figures:

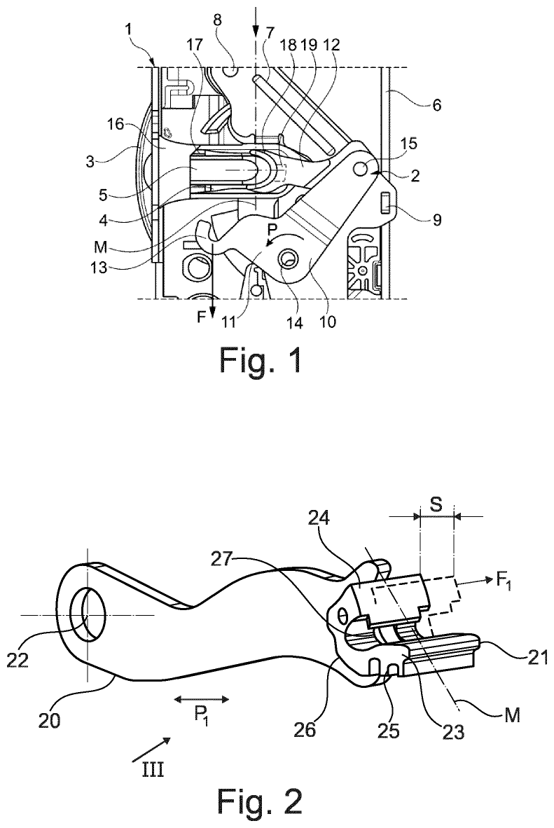

FIG. 1 shows a side view of a motor vehicle lock in a main latching position with a partially shown opening device and an engaged lock striker according to the prior art,

FIG. 2 shows a opener released from the motor vehicle lock and an opening device with a run-in buffer,

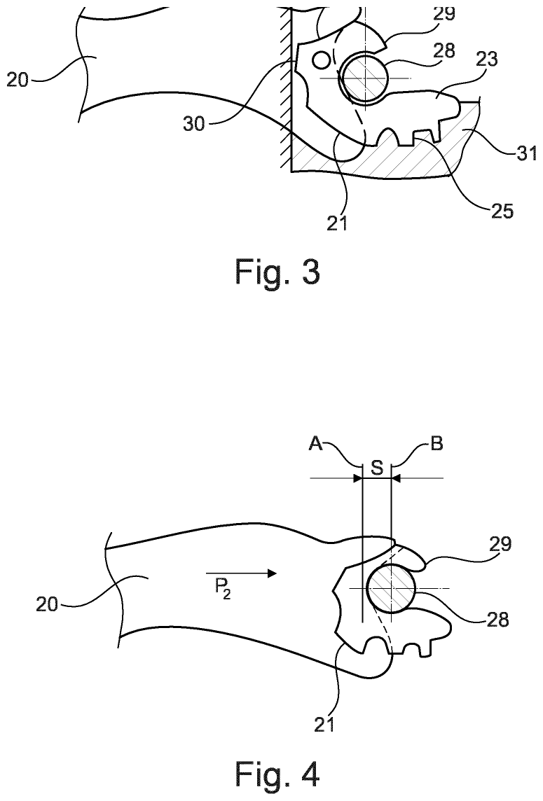

FIG. 3 shows a view of the opener and the run-in buffer from the direction of the arrow III from FIG. 2, wherein a first end position of the opener is portrayed, and

FIG. 4 again shows a view of the opener from the direction of the arrow III, wherein the second end position of the opener is portrayed.

FIG. 1 shows a side view of a motor vehicle closing device 1 and an opening device 2. The closing device 1 interacts with a lock striker 3. In this respect, a main latching position of the closing device 1 is shown, i.e., the movable component is in a closed position. The lock striker 3 is held in the main latching position of the locking mechanism by means of the rotary latch. The lock striker 3 is provided with a lock striker bracket 5, wherein the rotary latch 4 engages around a region of the lock striker bracket 5, accordingly securing the movable component.

In this exemplary embodiment, the motor vehicle closing device 1 has a U-shaped lock plate 6, in which at least the locking mechanism parts 4 are accommodated in a rotatably mounted manner. In addition, a reinforcement plate 7 can be seen, which on the one hand is connected to the reinforcement plate 7 by means of a bolt 8 and a receptacle 9. On the other hand, a part of the lever mechanism 10 of the opening device 2 is pivotably accommodated on the reinforcing plate 7. In this exemplary embodiment, the lever mechanism 10 consists of an operating lever 11 and an opener 12. The operating lever 11 has a suspension 13 into which, for example, one end of a Bowden cable not shown can be suspended. By means of the Bowden cable, a force F can be introduced into the lever mechanism 10 so that the operating lever 11 moves around the axle 14 in the direction of the arrow P, so that a force can be introduced into the opener 12. The lock plate 6, reinforcing plate 7, operating lever 11, and opener 12 are preferably made of a metallic material so that even high opening forces can be introduced into the lock striker 3. The opener 12 and operating lever 11 are pivotably connected to one another about an axle 15.

FIG. 1 also partially shows a part of the lock housing 16, wherein the lock housing 16 forms a run-in region 17 for the lock striker 3.

In this design variant, the opener 12 additionally assumes the function of a run-in buffer. In this exemplary embodiment, the run-in buffer 18 is formed integrally with the opener 12 and may, for example, be molded onto the opener 12 in the form of a rubber-elastic plastic. It is of course also conceivable that the rubber-elastic run-in buffer be connected to the opener 12 by means of a form-fit 19. The form-fit 19 is shown as a dashed line in FIG. 1 by way of example.

Together with the opener 12, the run-in buffer forms the damping means 12, 18 with which the lock striker 3 can be inserted into the motor vehicle closing device 1 in a noise-dampened manner. As can be clearly seen in FIG. 1, the ends of the run-in buffer 18 or of the opener 12 extend beyond a midline M of one end of the lock striker bracket 5. This ensures that a load in the Z direction can be applied to the lock striker 3 by means of the receptacle 12. The lock striker bracket 5 can accordingly be locked in the closing device 1 by means of the opener 12 and the run-in buffer 13. The opener 12 can be guided in the closing device 1 and, for example, through the lock housing 16 and/or the reinforcing plate 7.

In FIG. 2, an opener 20 is shown, released from a motor vehicle lock and an opening device, as a separate component with a run-in buffer 21. The opener 20 can, for example, be movable back and forth in the direction of the arrow P1 via its bearing point 22 using an opening device according to the prior art. By means of the opener 20, a movement of at least part of the run-in buffer 21 is achievable. The run-in buffer 21 can be divided into a stationary first part 23 and a movable second part 24.

The first part can, for example, be accommodated in a form-fit via ribs 25 in the housing of a motor vehicle lock. By means of the form-fit engagement of the ribs 25 in corresponding recesses of the housing, the run-in buffer 21 can be held stationary in the motor vehicle lock.

The second part 24 engages in the opener 20 in a form-fitting manner as shown in FIG. 2 so that a secure positioning of the second part 24 of the run-in buffer 21 can be ensured. The opener 20 engages the center of the run-in buffer 21 along a midline M of the run-in buffer 21. In addition to the form-fit between the run-in buffer 21 and the opener 20, the second part 24 can also be non-detachably connected to the opener 20. It is conceivable, for example, that the second part 24 be connected to the opener 20 by an adhesive process or by means of vulcanization.

If the opener 20 is now moved in the direction of the arrow P1 by means of the opening device, the second part 24 of the run-in buffer 21 can be moved along an adjustment path S. By moving the second part 24 of the run-in buffer 21, a lock striker released by a locking mechanism can experience a force F1, so that, for example, a motor vehicle door connected to the opener 20 can be opened via the path S. The opener 20, in conjunction with the run-in buffer 21, accordingly generates a relative movement between the movable component and the lock striker. To move the second part 24 of the run-in buffer 21, the run-in buffer 21 is deformed via a bending region 26. In this case, the opener 22 moves, for example, into a recess 27 of the run-in buffer 21 and can also be moved into the first part 23 if, for example, the recess 27 also extends into the first part 23 of the run-in buffer.

The design according to the invention of the interaction between the opener 20 and the run-in buffer 21 makes it possible to achieve, using minimal structural means, an opening of a component movably attached to the motor vehicle lock. Arranging the opener centrally in relation to the run-in buffer allows for the smallest possible realization of an opener design, i.e., an opening can be achieved in the smallest possible installation space.

Not shown, but also possible according to the invention, is that the run-in buffer 21 is moved by its movable second part 24 in such a way that, in addition to opening, it is also possible to hold the lock striker in the opened, i.e., open, position of the movable component. The run-in buffer 21 accordingly has a variety of functions such as damping, positioning, opening, and/or holding.

FIG. 3 shows a view of the opener in an end position or initial position in which the opener 20 is located when the movable component is in the closed position. This initial position A of the lock striker 28 accordingly represents the position of the lock striker and the arrangement of the opener 20 in the closed position of the movable component. The lock striker 28 rests on the opener 20 and the run-in buffer 21. For this purpose, the second part 24 of the run-in buffer 21 has at the end an extension or a holding means 29, which is located above the lock striker 28 in FIG. 3.

The first end position or initial position A shown in FIG. 3 shows the opener 20 in a retracted position. The second part 24 of the run-in buffer 21 is, for example, non-detachably connected to the opener 20. When the opener 20 moves back, a stop region 30 can come into contact with a housing 31 of the motor vehicle lock and accordingly provide a stop for the opener 20. The run-in buffer 21 accordingly also has the function of a damping means for the movement of the opener 20. The housing 31 is only indicated, but the interaction between the ribs 25 of the run-in buffer 21 and the housing 31 can also be seen, so that a stable connection between the run-in buffer 21 and the housing 31 can be established.

FIG. 4 also portrays the view from the direction of the arrow III towards the opener 20. However, what is shown here is the position of the opener 20 in the open position of the movable component, i.e., the opener 20 has moved the lock striker 28 from the first end position, starting position A, to the second end position, open position B. The opening movement is portrayed as path S in FIG. 4. It can be clearly seen that, due to the movement of the opener in the direction of the arrow P2, the extension extends at least partially around the lock striker 28 so that a holding engagement is established due to the interaction between the opener 20, run-in buffer 21, and lock striker 28. This creates the possibility of holding or fixing the movable component in its open or opened position by means of the opener 20 in conjunction with the run-in buffer. Since the run-in buffer 21 is made of an elastic material, the run-in buffer 21 can be deformed by the opener 20 in a simple manner, but at the same time, the high frictional resistance between the lock striker 28 and the run-in buffer 21 and/or the projection 29 of the extension 29 enables the movable component to be securely held.

| List of reference signs | |
|---|---|
| 1 | Motor vehicle closing device |
| 2 | Opening device |
| 3 | Lock striker |
| 4 | Rotary latch |
| 5 | Lock striker bracket |
| 6 | Lock plate |
| 7 | Reinforcing plate |
| 8 | Bolt |
| 9 | Receptacle |
| 10 | Lever mechanism |
| 11 | Actuating lever |
| 12 | Opener |
| 13 | Suspension |
| 14, 15 | Axis |
| 16 | Lock housing |
| 17 | Run-in region |
| 18 | Run-in buffer, damping means |
| 19 | Form-fit |
| 20 | Opener |
| 21 | Run-in buffer |
| 22 | Bearing point |
| 23 | First part |
| 24 | Second part |
| 25 | Ribs |
| 26 | Bending region |
| 27 | Recess |
| 28 | Lock striker |
| 29 | Extension |
| 30 | Stop |
| 31 | Housing |
| F, F1 | Force |
| P, P1, P2 | Arrow |
| M | Midline |
| S | Adjustment path |
| A | 1. End position, starting position |
| B | 2. End position, open position |

1. A motor vehicle lock having comprising:
a housing,
a lock striker,
a locking mechanism including:
a rotary latch, and
at least one pawl,
wherein the rotary latch is configured to be latched in at least one latching position by the at least one pawl,
wherein the locking mechanism is in engagement with the lock striker;
a run-in buffer arranged in the housing,
wherein the run-in buffer is in engagement with the lock striker; and
an opening device,
wherein the opening device has an opener,
wherein the opener is in engagement with the lock striker, and
wherein the opener is configured to interact with the run-in buffer.

2. The motor vehicle lock according to claim 1, wherein the run-in buffer is configured to be moved at least partially by the opener.

3. The motor vehicle lock according to claim 1, wherein the run-in buffer is at least partially accommodated in the housing of the motor vehicle lock.

4. The motor vehicle lock according to claim 1, wherein the run-in buffer is at least partially connected to the opener.

5. The motor vehicle lock according to claim 4, wherein the run-in buffer is detachably connected to the opener.

6. The motor vehicle lock according to claim 4, wherein the run-in buffer is non-detachably connected to the opener.

7. The motor vehicle lock according to claim 1, wherein the opener in engagement with the run-in buffer in a center of the run-in buffer.

8. The motor vehicle lock according to claim 1, wherein a relative movement between the motor vehicle lock and the lock striker is produced by a movement of the run-in buffer.

9. The motor vehicle lock according to claim 1, wherein the run-in buffer at least partially encloses the lock striker.

10. The motor vehicle lock according to claim 1, wherein the run-in buffer is in engagement with the lock striker in a form-fitting manner.

11. The motor vehicle lock according to claim 1, wherein the opener is held in at least one end open position by the run-in buffer.

12. The motor vehicle lock according to claim 1, wherein the run-in buffer is configured for damping at least one end position of the opener.

13. The motor vehicle lock according to claim 1, wherein the motor vehicle lock is designed as an electrically opening motor vehicle lock.

14. The motor vehicle lock according to claim 1, wherein the run-in buffer serves as a guide for the opener.

15. The motor vehicle lock according to claim 5, wherein the run-in buffer and the opener are detachably connected by a form-fit.

16. The motor vehicle lock according to claim 5 wherein the run-in buffer and the opener are detachably connected by a force-fit.

17. The motor vehicle lock according to claim 1, wherein the opener is configured to act on the run-in buffer such that the locking mechanism in an unlocked position releases the lock striker.
